(19) United States
(12) Patent Application Publication
(10) Pub. No.: US 2010/0290844 A1
(43) Pub. Date: Nov. 18, 2010

(54) ARRANGEMENT FOR THE CONTACTLESS TRANSPORT OF FLAT SUBSTRATES

(75) Inventors: Hans-Peter Voelk, Griesingen (DE); Robert Michael Hartung, Blaubeuren (DE)

Correspondence Address: HESLIN ROTHENBERG FARLEY & MESITI PC, 5 COLUMBIA CIRCLE, ALBANY, NY, 12203, US

(73) Assignee: CENTROTHERM THERMAL SOLUTIONS GMBH+CO.KG, Blaubeuren (DE)

(21) Appl. No.: 12/669,515

(22) PCT Filed: Jul. 21, 2008
(86) PCT No.: PCT/EP2008/059530

§ 371 Date: May 12, 2010

(30) Foreign Application Priority Data
Jul. 19, 2007 (DE) 10 2007 033 944.7

(51) Int. Cl. B65G 51/02

(52) U.S. Cl. 406/92

(57) ABSTRACT

An arrangement for the contactless transport of flat substrates, particularly of square or rectangular plates having high breakability along a transport path, is provided. With the arrangement, the substrates can be reliably accelerated, transported and slowed down even in the overhead position, independently from the ambient atmosphere and ambient temperature. This is achieved by a plurality of Bernoulli grippers being arranged on both sides along a transport path at a distance behind each other such that the substrate to be transported covers the Bernoulli grippers on both sides of the transport path only partially. The Bernoulli grippers each create a gas flow rotating clockwise or counterclockwise relative to the substrate and directed in the transport direction, wherein the Bernoulli grippers of each pair create each a differently rotating gas flow. Mechanical lateral guide elements are provided on both sides of the transport path.

The invention concerns an arrangement for contactless transport of flat substrates, especially square or rectangular plates with high fracture sensitivity, along a transport path.

The substrates to be transported, for example, through heated process chambers, can consist of plates of any sufficiently flexible, but very fracture-sensitive materials, like glass, silicon or graphite. It is therefore useful to use almost contactless transport systems for transport of such substrates.

A closed system for transport of semiconductor wafers by means of a gaseous transport medium to and from processing stations was known from DE 26 44 055 A1. The transport medium is self-centering, so that the semiconductor wafers are always transported in the center along the transport path. For this purpose, a gas cushion is produced beneath the semiconductor wafers with directed forces for centering and forward movement by means of semicircular gas nozzles. Stopping of movement occurs here by means of vacuum stopping devices, which temporarily fix the semiconductor wafers at the prescribed locations.

The underlying task in the invention is to devise an arrangement for contactless transport of flat substrates, with which the substrates can also be reliably accelerated, transported and slowed down again overhead, independently of the surrounding atmosphere and ambient temperature.

The task underlying the invention is solved by the characterizing features of the main claim. Additional embodiments of the invention are apparent from the corresponding dependent claims.

The arrangement according to the invention uses the known Bernoulli effect.

For this purpose, a number of Bernoulli grippers are arranged on both sides of a transport path spaced one behind the other, so that the substrate being transported only partially covers the Bernoulli grippers on both sides of the transport path, so that the Bernoulli grippers each generate a gas stream rotating to the right or left, directed toward the substrate and in the transport direction, the Bernoulli grippers each generating a pair of differently rotating gas streams, and that mechanical lateral guide elements are provided on both sides of the transport path.

With the invention it is possible without any problems to also grip and transport textured substrates/wafers on the textured side, even overhead.

Rails or limitation strips are considered as lateral guide elements.

In a continuation of the invention, the Bernoulli grippers, following each other on both sides along the transport path, are designed to form right- or left-rotating gas streams in alternation. By operating each second pair with a gas, one transport direction can be implemented and by operating the other second pair of Bernoulli grippers with a gas, an opposite transport direction can be implemented. Reversal of the transport direction can also be achieved by operating the Bernoulli grippers accordingly.

In one variant of the invention, each Bernoulli gripper is switchable in the flow direction of the gas, so that right- and left-rotating gas streams can be generated in succession.

In another embodiment of the invention, Bernoulli grippers, with an advance direction opposite the other Bernoulli grippers, are arranged at the end of the transport path. In this way, a braking effect on the transported substrates can be achieved at the end of the transport path.

The Bernoulli grippers can be arranged along the transport path on a flat base or be inserted or fit into it flush with the surface.

In order to guarantee reliable transport of the substrates even at higher temperatures or under aggressive media, the base, optionally including the Bernoulli grippers, can also consist fully of graphite. The grippers can also be operated at temperatures around 1000° C. and even in an H₂ atmosphere. In this case, the process gas and the gas with which the Bernoulli grippers are operated can be identical. The gas can be preheated, or also circulated, so that temperature problems can be avoided. Commercial graphite pumps are suitable for this purpose.

In another embodiment of the invention, the Bernoulli grippers have a cup-like configuration, in which at least one outflow opening for compressed air or another gas in the tangential direction is arranged on its inner side wall.

The outflow opening can also have a slight angling upward, i.e., in the direction of the substrates being transported, so that a distinctly upward directed gas stream rotating in a spiral is formed.

In order to achieve a particularly uniform gas stream, it is advantageous, if two opposite outflow openings aligned in the same direction are provided in the inner side wall of each Bernoulli gripper.

Finally, an additional pair of outflow openings with opposite alignment can be arranged in the inner side wall, in order to achieve a switchable direction of rotation of the gas stream during corresponding exposure to a pressurized gas.

The arrangement according to the invention can also be easily used for overhead transport with suspended substrates.

In suspended transport, the substrate can be taken up/drawn in by a base particularly simply. The substrate for this purpose must be passed/moved close to the Bernoulli grippers until the Bernoulli effect sets in.

Uphill transport of the substrates up to a slope of about 30° is possible without any problems. The already described braking effect must then be utilized downhill.

The invention will be further explained below in a practical example.

In the corresponding figures of the drawing:

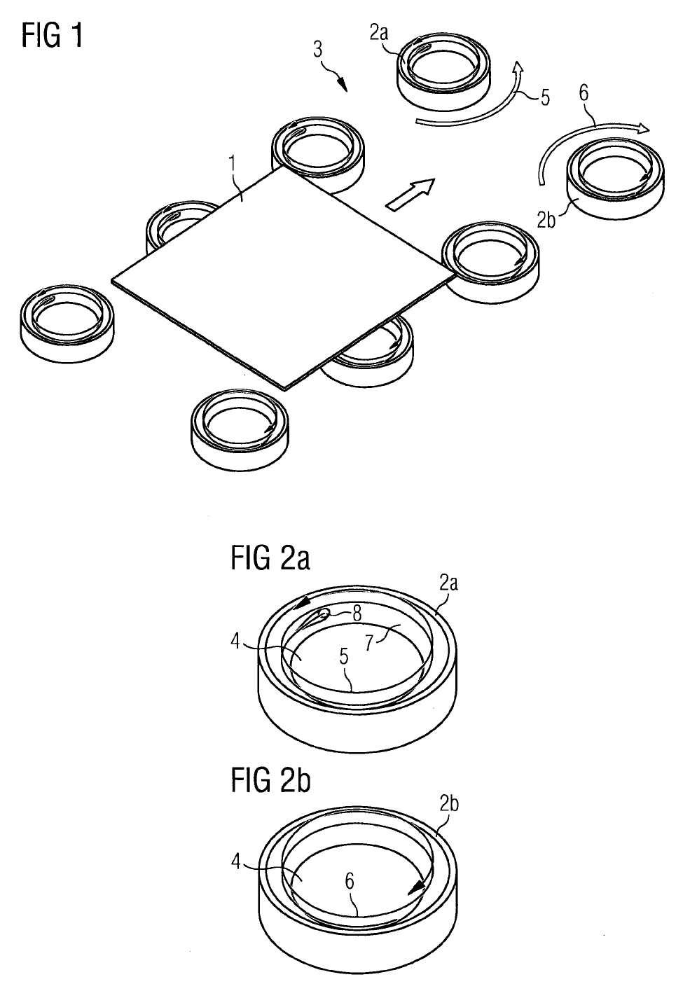

FIG. 1: shows a schematic perspective view of a device according to the invention for contactless transport of flat substrates;

FIG. 2a: shows a Bernoulli gripper with a left-rotating gas stream; and

FIG. 2b: shows a Bernoulli gripper with a right-rotating gas stream.

FIG. 1 shows a schematic view of a device according to the invention for contactless transport of flat substrates 1 in the form of square or rectangular plates with high fracture sensitivity, for example, substrates for solar cells, along a transport path 3 with two rows of cup-like Bernoulli grippers 2a, 2b on the side of the transport path 3.

The spacing of the Bernoulli grippers 2a, 2b relative to each other to the right and left of the transport path 3 is greater than the width of the substrates 1 and such that the substrates 1, on passing by, cover about half the opening 4 of the corresponding Bernoulli gripper 2a, 2b, at most. The Bernoulli grippers 2a of the left row generate a left-rotating gas stream 5 and the Bernoulli grippers 2b of the right row a right-rotating air stream 6, each in the direction toward the substrate being transported and, at the same time, in transport direction 3.

Textured wafers are also considered as substrates 1, in which these can be simply gripped on the textured side.

The Bernoulli grippers 2a, 2b can then be arranged on a base made of any material or inserted or fit into it flush with the surface. A graphite plate can be used as a base, so that reliable use is guaranteed even at higher temperatures up to about 1000° C. The base and the Bernoulli grippers 2a, 2b can also consist of another thermally loadable and sufficiently chemically resistant material, like ceramic.

FIG. 2a shows a Bernoulli gripper 2a with a left-rotating gas stream 5 and FIG. 2b a Bernoulli gripper 2b with a right-rotating gas stream 6.

Details of the Bernoulli grippers 2a, 2b are apparent from FIG. 2. They have a cup-like configuration with an opening 4 in the direction toward the substrate 1 being transported and are equipped on the inner side wall 7 with at least one outflow opening 8 (nozzle) in the tangential direction for compressed air or another gas, for example, a process gas. The nozzle 8 can have a slight angling upward in the direction toward opening 4, so that an upward directed gas stream 5; 6 rotating in a spiral is formed.

If the Bernoulli grippers are made completely from graphite, they can be operated without any problems at temperatures around 1000° C. even in an H₂ atmosphere. The process gas and the gas, with which the Bernoulli grippers are operated, can be identical here. The gas can be preheated or also circulated, so that temperature problems can be avoided. Commercial graphite pumps are suitable for this purpose.

Two outflow openings 8 aligned in the same direction opposite each other are preferably provided in the inner side wall 7 of each Bernoulli gripper 2a, 2b, so that more uniform gas stream 5; 6 is achieved.

In order to accomplish different directions of rotation of the gas stream 5, 6 with the same Bernoulli grippers 2a; 2b, an additional pair of outflow openings (not shown) can be provided in the inner side wall 7, which then generate an opposite direction of rotation of a gas stream with corresponding control.

The Bernoulli grippers 2a arranged to the left of the transport path 3 generate a left-rotating gas stream 5 and the Bernoulli grippers 2b arranged to the right of the transport path 3 generate a right-rotating gas stream 6, so that a gripped substrate 1, which must be positioned for this purpose directly above the Bernoulli grippers, as shown in FIG. 1, then “floats” on the air cushion and is transported forward along the transport path 3 by an advance force generated by the gas flow in conjunction with the surface roughness of substrates 1.

Right-rotating is to be understood to mean rotating clockwise and left-rotating to mean counterclockwise.

If transport in both directions along the transport path 3 is to be accomplished, the already described Bernoulli grippers, switchable in direction of rotation of the gas stream, can be used.

The other possibility consists of arranging Bernoulli grippers 2a, 2b with right- and left-rotating gas stream in alternation to the right and left of the transport path 3, in which the Bernoulli grippers 2a, 2b, arranged opposite each other in pairs along the transport path 3, each must have an opposite direction of rotation, just like the Bernoulli grippers 2a, 2b situated one behind the other on both sides along the transport path 3.

Each second pair of Bernoulli grippers 2a, 2b then generates an advance force in the same direction. By switching the outflow openings 8 of the pairs of the same transport direction, reversal of the transport direction can be simply achieved.

It is also possible to reduce the transport speed toward the end of the transport path by temporarily switching pairs of Bernoulli grippers 2a, 2b there with opposite direction of advance to generate a braking effect.

If particularly large substrates are to be transported, additional Bernoulli grippers 2a; 2b can be arranged as center support in the middle of the transport path 3. These additional Bernoulli grippers 2a; 2b need not necessarily generate an air stream 5; 6 rotating in a spiral. The Bernoulli grippers situated on the edge of the transport path 3 then also assume the advance function, as already described, then being arranged only farther apart.

Curves can even be negotiated by assigning several curve-outer Bernoulli grippers with opposite direction of rotation to the curve-inner Bernoulli grippers.

The particular advantages of the invention are seen in the fact that it can be used in different atmospheres, i.e., at high and low temperatures and under aggressive atmospheres.

By a targeted choice of material for the Bernoulli grippers, the arrangement according to the invention can also be used at particularly high temperatures. Graphite can be used as material for the Bernoulli grippers under an oxygen atmosphere up to 500° C.

### Arrangement for Contactless Transport of Flat Substrates

### LIST OF REFERENCE NUMERALS

1 Substrate

2a Bernoulli gripper

2b Bernoulli gripper

3 Transport path

4 Opening

5 Left-rotating gas stream

6 Right-rotating gas stream

7 Inner side wall

8 Outflow opening

1. Arrangement for contactless transport of flat substrates in the form of square or rectangular plates of high fracture sensitivity along a transport path, comprising a number of Bernoulli grippers are arranged on both sides of a transport path at a spacing one behind the other, so that a substrate being transported covers the Bernoulli grippers on both sides of the transport path only partially, the Bernoulli grippers each generate a right- or left-rotating gas stream directed toward the substrate and in the transport direction, wherein the Bernoulli grippers of a pair each generate a differently rotating gas stream, and further comprising mechanical lateral guide elements provided on both sides of the transport path.

2. Arrangement according to claim 1, wherein the lateral guide elements comprise rails or limitation strips.

3. Device according to claim 1, wherein the Bernoulli grippers following each other on both sides along the transport path, form right- or left-rotating gas streams in alternation.

4. Device according to claim 1, wherein each Bernoulli gripper can be switched, so that it generates right- and left-rotating gas streams in succession.

5. Device according to claim 1, wherein Bernoulli grippers, with an advance direction opposite the other Bernoulli grippers, are arranged at an end of the transport path.

6. Device according to claim 1, wherein the Bernoulli grippers are arranged on a flat base.

7. Device according to claim 6, wherein the Bernoulli grippers are inserted or fitted flush into the base.

8. Device according to claim 6, wherein the Bernoulli grippers and the base comprise graphite.

9. Device according to claim 1, wherein the Bernoulli grippers have a cup-like configuration, and at least one outflow opening for compressed air or another gas in a tangential direction on an inner side wall.

10. Device according to claim 9, wherein the outflow opening is arranged with a slight angling upward in a direction toward the substrates being transported, so that an upward directed gas stream rotating in a spiral is formed.

11. Device according to claims 9, wherein two opposite outflow openings aligned in the same direction are provided in the inner side wall of each Bernoulli gripper.

12. Device according to claim 11, further comprising an additional pair of outflow openings with opposite alignment in the inner side wall.
